(19) United States
(12) Patent Application Publication
(10) Pub. No.: US 2005/0218573 A1
(43) Pub. Date: Oct. 6, 2005

(54) ATV coil spring preload equalizing adjuster

(75) Inventor: Frank Verriet, Mississauga (CA)

Correspondence Address: CARLSON, GASKEY & OLDS, P.C., 400 WEST MAPLE ROAD, SUITE 350, BIRMINGHAM, MI, 48009, US

(73) Assignee: Arvin Technologies, Inc.

(21) Appl. No.: 11/145,729

(22) Filed: Jun. 6, 2005

Related U.S. Application Data
(63) Continuation-in-part of application No. 10/463,162, filed on Jun. 17, 2003.

(51) Int. Cl. B60G 21/06

(52) U.S. Cl. 267/186

(57) ABSTRACT

A suspension system includes multiple shock absorbers and corresponding preload cylinders. A single adjuster mechanism is within reach of a vehicle operator for easily changing a suspension ride height of two of the preload cylinders.

The present invention is a continuation-in-part of U.S. patent application Ser. No. 10/463,162, filed Jun. 17, 2003.

### BACKGROUND OF THE INVENTION

The present invention relates to an adjuster mechanism and more particularly to an adjuster mechanism for use in adjusting a spring preload such as for an off road vehicle (ORV) or all terrain vehicle (ATV).

Suspension systems in vehicles are commonly subjected to varying road conditions. This is especially true in ORVs, ATVs, snowmobiles, and the like. These vehicles may have adjustable suspension systems to accommodate the preferences of the vehicle operator on irregular terrain. Known systems that allow for one remote adjuster for all shock absorbers have been directed toward adjustment of the internal pressure of the shock absorber, as opposed to an external preload cylinder.

Preload cylinders have been connected to, and are typically concentric with, shock absorbers for adjusting the spring preload of the shock absorber assembly. The preload cylinder may support a suspension spring associated with the shock absorber. Adjustment of the preload cylinder varies the load placed on the suspension springs thus increasing or decreasing the suspension load carrying capacity. A desired ride comfort level, provided by the suspension ride height, varies from operator to operator. For example, the weight of the operator affects the performance of the suspension system. The effect of varying weight is especially noticeable on the performance of suspension systems in smaller vehicles like snowmobiles and ATVs.

Many systems have the ability to adjust the suspension while the vehicle is in operation by providing an adjustment mechanism within reach of the operator. In one proposed adjustment system for a motorcycle there are two shock absorbers which are adjustable through a single control. This system uses a compressible fluid. The compressible fluid in the prior art system would allow fluid to flow from one shock absorber to another when a force is applied to one side of the vehicle. That is, the compressible fluid will not resist the force.

Accordingly, it is desirable to provide a suspension adjustment system which allows for equal preload adjustment.

### SUMMARY OF THE INVENTION

The suspension system according to the present invention provides a system for making equal adjustments to a plurality of preload cylinders.

The suspension system includes multiple shock absorbers and corresponding preload cylinders. The height of the preload cylinders is adjustable by a lever attached to an adjuster mechanism. The adjuster mechanism is within reach of a vehicle operator for easily changing the suspension height while the vehicle is in operation. Changes to the position of the adjuster mechanism will correspondingly adjust the position of all the preload cylinders and thus vary the spring preload of a spring associated with the shock absorber.

As disclosed, there are at least two shock absorbers and preload cylinders connected to an adjuster mechanism. Changes in the adjuster mechanism will affect all preload cylinders equally. Thus, only one adjuster mechanism is needed. The system may be used on front and/or rear shock absorbers.

The system has incompressible fluid within the adjuster mechanism. The incompressible fluid ensures that a force on one side of the vehicle will be resisted by the suspension on the other side of the vehicle.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general schematic view of the suspension system of the present invention;

FIG. 2 is a partial cross-sectional view of the shock absorber and preload cylinder of the present invention; and

FIG. 3 is a side view of an adjuster mechanism of the present invention.

### DETAILED DESCRIPTION OF THE PREFERRED EMBODIMENT

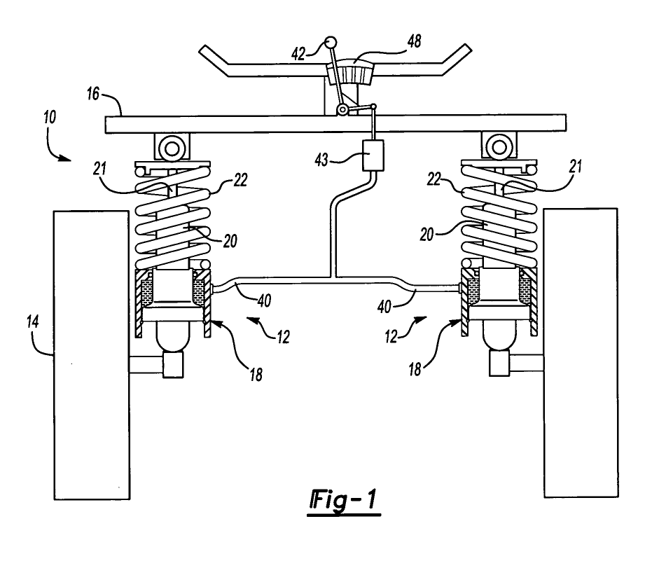

FIG. 1 illustrates a suspension system 10 in an ATV, shown schematically. The suspension system 10 includes a shock absorber 12 mounted between a wheel 14 and a vehicle body 16. The mounting structure is shown schematically and may be as known. The shock absorber 12 has a preload cylinder 18. The preload cylinder 18 is mounted between a shock absorber housing 20 and a coil spring 22.

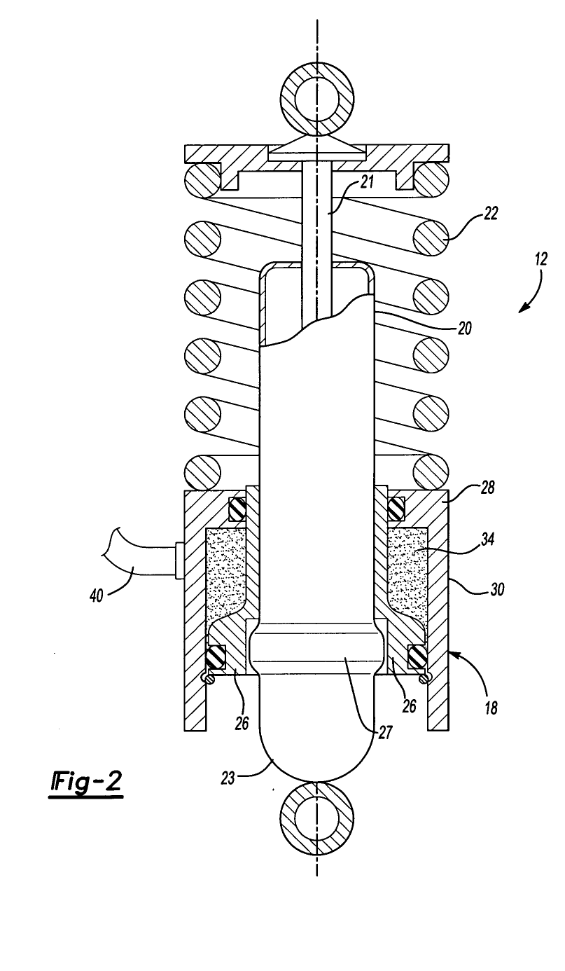

The preload cylinder 18, shown in FIG. 2, is arranged about the shock absorber 20. The shock absorber 20 is as known, including a piston 21 movable within a housing 23. An outer wall 30 of the preload cylinder 18 is spaced apart from the shock absorber 20 to form an internal chamber 34. As is known, the spring 22 provides some control over the ride characteristics of the shock absorber 20. The spring force of the spring 22 can be adjusted to adjust the initial preload force, as known. This adjustment is the function of the preload cylinder 18. Hydraulic fluid within the preload cylinder 18 adjusts the position of the preload cylinder, which in turn allows the spring to expand, or causes the spring to contract to adjust the preload force, again as known.

A lower wall 26 of the internal chamber 34 is supported by a dimple 27 extending from the shock absorber housing 20. The outer wall 30 extends down, past the lower wall 26. This allows the size of the preload cylinder 18 to be adjusted without allowing fluid leakage and pressure loss to the internal chamber 34. The upper surface 28 of the preload cylinder 18 supports the coil spring 22.

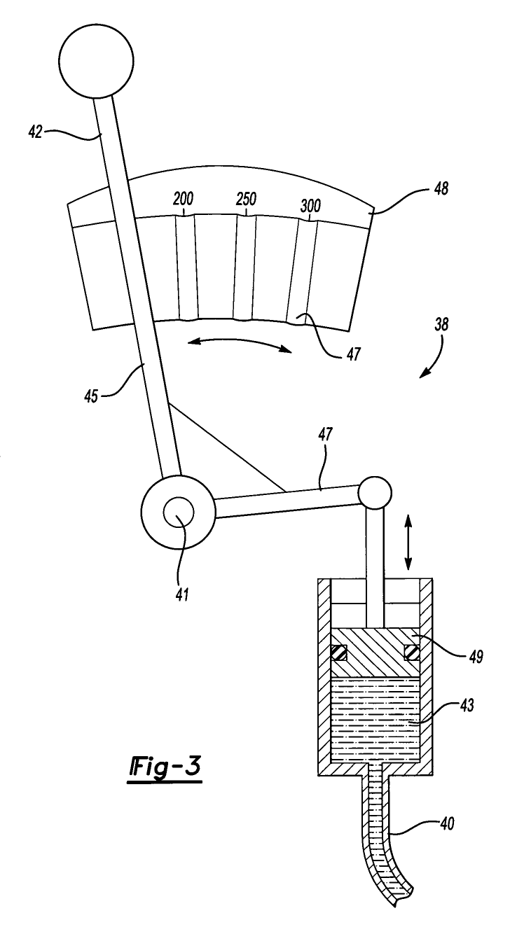

An adjuster mechanism 38 is shown in FIG. 3. The adjuster mechanism 38 is located remotely from the preload cylinder 18. As is shown in FIG. 1, adjuster mechanism 38 may be mounted on the handlebars or in some other position within easy reach of the vehicle operator. The adjuster mechanism 38 is moveable between a plurality of positions which correspond to positions of the preload cylinder 18. The adjuster mechanism 38 is connected to preload cylinders 18 associated with a pair of shock absorbers 20 by a fluid line 40.

Adjusting a lever 42 changes the position of the adjuster mechanism 38 resulting in an increase or decrease the amount of fluid that is in the preload cylinder 18. The adjuster mechanism 38 includes a fluid reservoir 43. Moving lever 42 will cause a first mechanism arm 45 to pivot about fixed pivot 41, which in turn causes a second mechanism arm 47 to pivot. As the first and second mechanism arms 45 and 47 pivot, a reservoir piston 49 moves inwardly or outwardly of reservoir 43. The change in the position of reservoir piston 49 will increase or decrease the amount of hydraulic fluid in the fluid reservoirs 43. As mentioned, fluid reservoir 43 is fluidly connected to the internal chamber 34 of the preload cylinders 18 by fluid line 40. Thus, by moving the lever 42, the relative amount of fluid in the internal chambers 34 can be varied. As the fluid in the internal chambers is varied, the position of wall 30 changes and hence the length of spring 22 changes.

Because the preload chambers 34 are connected hydraulically by the fluid line 40, fluid pressure remains constant across both chambers resulting in a balanced preload force between the two chambers. Fluid will transfer from one chamber 34 to the other connected chamber 34 in order to keep pressure equal, and the total fluid volume in both chambers 34 plus the fluid line 40 will remain constant. Therefore the amount of preload cylinder stroke available in the assembly 18 must be limited so as not to allow excessive displacement difference between one side and the other connected assemblies 18, the amount which depends on the specific vehicle application. In addition, the size of the cross sectional flow area of the fluid line 40 can be designed to control the speed at which the connected chambers 34 can equalize, preventing sudden bumps from offsetting the vehicle.

A scale 48 is used to designate an appropriate position for lever 42 given a particular load on the suspension system. For example, scale 48 may have detents given in weight increments. Thus, a system operator may adjust the setting to reflect the payload that will be placed on the suspension system. The payload setting may be the passenger's weight, for example. The adjuster mechanism 38 then makes the appropriate adjustments to reflect the change. The embodiment shown utilizes a lever and scale display. However, it should be known that an electronic control and display may be used as well.

Of course, a user may determine that a position on the scale higher or lower than the user's actual weight may be most desirable given the particular ride height level the user would like. However, the scale setting based upon weight would provide that user with the ability to make an intelligent choice to begin the process of selecting the desired position.

The adjuster mechanism 38 may be attached to two shock absorbers 12. Alternatively, the system may be used with all of the shock absorbers on the vehicle.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A suspension system comprising:
at least two shock absorbers each having a preload cylinder adjustable between a plurality of spring preloads; and
an adjuster mechanism connected to each of said preload cylinders, said adjuster mechanism movable between a plurality of positions corresponding to said plurality of spring preloads to adjust each of said preload cylinders an equal amount.

2. The suspension system as recited in claim 1, wherein said adjuster mechanism includes a fluid reservoir that is fluidly connected to each of said preload cylinders.

3. The suspension system of claim 2, wherein said incompressible fluid is received in said preload cylinders and in said fluid reservoir.

4. The suspension system as recited in claim 1 wherein said adjuster mechanism is movable along a scale to select one of plurality of positions for adjusting said preload cylinders to one of said plurality of spring heights in relation to a load on the suspension system.

5. The suspension system as recited in claim 4, wherein said scale displays increments based on units of weight

6. The suspension system as recited in claim 4, wherein said adjuster mechanism includes a lever and said lever being movable along said scale.

7. The suspension system as recited in claim 4, wherein said adjuster mechanism is remote from said preload cylinder.

8. The suspension system as recited in claim 1, wherein a spring is supported by said preload cylinder.

9. The suspension system of claim 1, wherein the suspension system is for use on an all terrain vehicle.

10. An all terrain vehicle comprising:
a vehicle frame, and at least two vehicle wheels;
a shock absorber associated with each of said vehicle wheels, and a preload cylinder associated with each of said shock absorbers, a spring mounted in abutment with each of said preload cylinders, and between a portion of said frame and said preload cylinder; and
an adjuster mechanism for adjusting an amount of hydraulic fluid in said preload cylinders, to in turn adjust a spring preload force provided by said springs, said adjuster mechanism having a lever movable relative to a scale, said scale including a plurality of incremental positions for said lever with indicia indicating an approximate payload on said vehicle, and such that as said lever is moved to any one of said incremental positions, the amount of hydraulic fluid delivered to said preload cylinders varies.

11. The all terrain vehicle as recited in claim 10, wherein said indicia corresponds to a weight of a passenger.

12. The all terrain vehicle as recited in claim 10, wherein said indicia displays increments based on units of weight.

13. The all terrain vehicle as recited in claim 10, wherein said adjuster mechanism includes a fluid reservoir that is fluidly connected to each of said preload cylinders.

14. The all terrain vehicle as recited in claim 10, wherein said adjuster mechanism is remote from said preload cylinders.
